(19) United States
(12) Patent Application Publication
(10) Pub. No.: US 2007/0106770 A1
(43) Pub. Date: May 10, 2007

(54) Managing a remote device by a communication element that does not specify an identifier for the management object

(76) Inventor: Svante Alnas, Lund (SE)

Correspondence Address: ERICSSON INC., 6300 LEGACY DRIVE, M/S EVR 1-C-11, PLANO, TX, 75024, US

(21) Appl. No.: 11/272,219

(22) Filed: Nov. 10, 2005

(51) Int. Cl. G06F 15/173

(52) U.S. Cl. 709/223

(57) ABSTRACT

A communication element used for remote management of information in a data processing apparatus includes an informational content portion and an identification portion associated with the informational content portion. During processing of the communication element, and in response to the identification portion, the informational content portion is used to produce an identifier to be associated with information contained in the informational content portion.

### FIELD OF THE INVENTION

The invention relates generally to data processing and, more particularly, to remote management of information in data processing devices.

### BACKGROUND OF THE INVENTION

Device management (DM) technology enables the customization, personalization, and servicing of client devices such as wireless phones, personal digital assistants, and data processing technology embedded in cars, houses, clothes, etc. Essentially, DM encompasses all of the necessities for remotely configuring, updating, and repairing client devices operating in the field.

One known technology for enabling DM is Open Mobile Access (OMA) DM. As is known in the art, OMA DM specifies mechanisms and protocols that help achieve management of devices. OMA DM is used to set and retrieve management information from devices where management information includes data such as configuration settings, user preferences, application settings, software and firmware updates, etc.

Currently, an OMA DM server initiates and controls management actions with a client device. For example, the OMA DM server can ask for client device information (e.g., status, queued events, application information, current parameters, etc.), send management commands (e.g., content/application download, parameter settings, etc.), collect results from the client device, as well as perform other management functions.

In a client device, the matters to be managed are arranged as management objects. Management objects are entities in the client device that can be managed by management commands of the management server. A management object may be, for instance, a simple integer, or a figure or other large entity, such as a background image or a screen saver. Some management objects have been standardized by OMA.

In OMA DM, the management objects are arranged in the form of a management tree. The management tree is formed of nodes. The management object is a subtree to the management tree and can be formed of one or more nodes. The nodes that form the desired management object are dealt with by OMA DM. A node can be a single parameter containing different types of data, for example, simple characters, integers, complex XML files, or binary data. The contents of a node may also be a link addressing another node. Each node can be addressed with a URI (Uniform Resource Identifier). So, within an OMA DM command that performs a desired operation with respect to a desired management object, a URI is provided to address the appropriate node in the management object. The above-described management tree structure and URI addressing used in OMA DM are well known in the art.

In some situations, the managing entity (i.e., on the server side of the DM model) does not know the URI that should be included in the desired OMA DM command. This is the case, for example, when a smartcard bootstrap is performed. The managing entity is a smartcard that is inserted into a clean, empty client device. The smartcard is cooperable with the client device to execute a so-called bootstrap process (that transforms the client device from the clean, empty (un-provisioned) state into a (provisioned) state where it is able to initiate (or respond to external initiation of) a management session with a managing server. However, the smartcard does not know what client device it will be inserted into, therefore also does not know the management tree structure of the client device, and so cannot specify the URI for the OMA DM command. Also with respect to bootstrapping, a non-clean client device, e.g., one that has already been bootstrapped, may need to be further bootstrapped in order to enable the device to be managed by further operators (further DM servers).

It is desirable in view of the foregoing to provide a capability for executing an OMA DM command that has been sent to a client device by a managing entity that cannot specify the URI for that OMA DM command

### SUMMARY OF THE INVENTION

According to exemplary embodiments of the invention, a communication element used for remote management of information in a data processing apparatus includes an informational content portion and an identification portion associated with the informational content portion. During processing of the communication element, and in response to the identification portion, the informational content portion is used to produce an identifier to be associated with information contained in the informational content portion.

### BRIEF DESCRIPTION OF THE DRAWINGS

FIG. 1 diagrammatically illustrates an arrangement for remote information management according to exemplary embodiments of the invention.

FIG. 2 diagrammatically illustrates the managed apparatus of FIG. 1 in more detail according to exemplary embodiments of the invention.

FIG. 3 illustrates exemplary operations that can be performed by the managed apparatus of FIGS. 1 and 2.

FIG. 4 diagrammatically illustrates the managing apparatus of FIG. 1 in more detail according to exemplary embodiments of the invention.

FIG. 5 illustrates exemplary operations that can be performed by the managed apparatus of FIGS. 1 and 4.

### DETAILED DESCRIPTION

The present invention recognizes that, when an OMA DM command presents a management object and its corresponding management object identifier in a data structure having data type TNDS (Tree and Description Serialization) and having data format XML or WBXML, such a data structure is self-explaining. More specifically, the management object identifier as presented in this TNDS data structure (also referred to as a TNDS data object) can be used on the client side to resolve the URI for the location where the client will store management object presented in the TNDS structure. In situations where the managing entity does not know the URI for the management object, and thus cannot provide the URI in the OMA DM command, exemplary embodiments of the invention exploit the aforementioned self-explaining TNDS data structure to produce the appropriate URI for the management object.

Some embodiments provide a reserved URI that can be included in the OMA DM command when the managing entity does not know the URI for the management object in the client device. The presence of the reserved URI in the OMA DM command serves to signal the client side to use the management object identifier presented in the TNDS structure to resolve the URI for the management object presented in the TNDS structure instead of the URI in the OMA DM command.

The aforementioned self-explaining TNDS data structure, and the use of such a data structure to present one or more management objects and corresponding management object identifiers in an OMA DM command, are well known in the art.

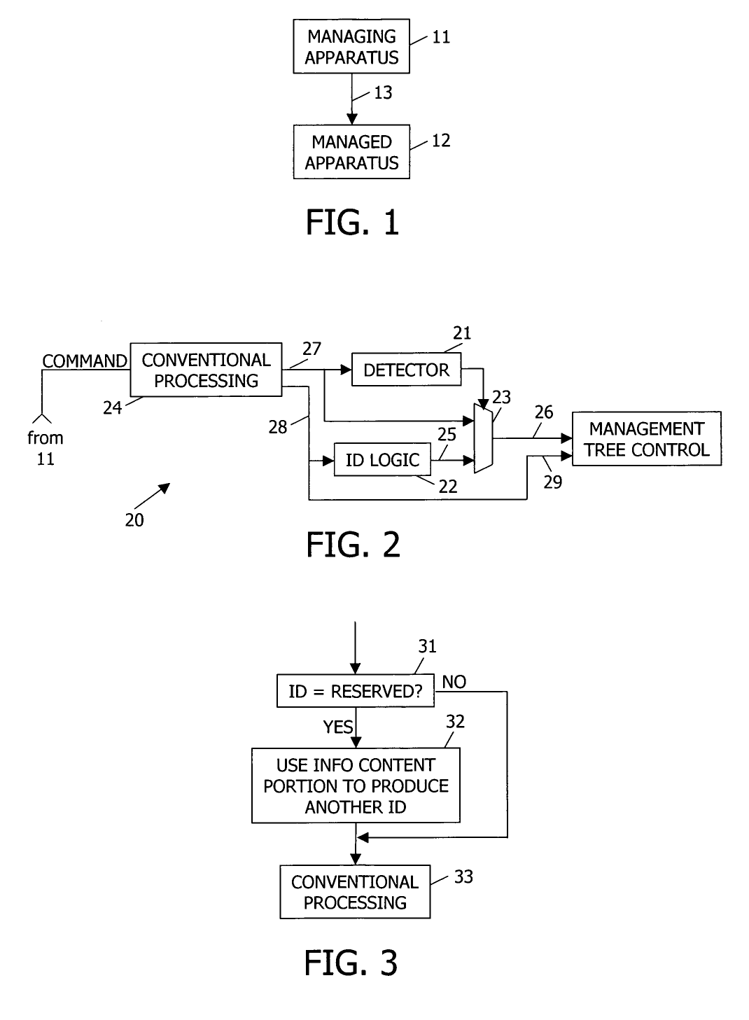

FIG. 1 diagrammatically illustrates a system that performs remote information management according to exemplary embodiments of the invention. The system of FIG. 1 includes a managing (e.g., server side) apparatus 11 and a managed (e.g., client side) apparatus 12, coupled for communication therebetween by a communication path 13. In various exemplary embodiments, the managing apparatus 11 includes, for example, a network server, a personal computer (PC), a smartcard, etc. In various exemplary embodiments, the managed apparatus 12 includes, for example, a PC, a portable data processing apparatus such as a wireless telephone, a personal digital assistant, a laptop computer, or a data processor embedded in a mobile environment such as a car or clothing, etc. In various exemplary embodiments, the communication path 13 includes conventionally available communication interfaces and infrastructure as needed to couple the managing apparatus 11 and the managed apparatus 12 for communication therebetween.

FIG. 2 diagrammatically illustrates the managed apparatus 12 of FIG. 1 in more detail according to exemplary embodiments of the invention. The managed apparatus of FIG. 2 includes logic designated generally at 20 for processing an incoming communication element, for example, a device management command. Conventional processing designated generally at 24 can be used to obtain the identification portion 27 and the informational content portion 28 from the incoming command. In some embodiments, the incoming command is an OMA DM command, the identification portion 27 is the URI portion of the OMA DM command, and the informational content portion 28 is the data portion of the OMA DM command. In some embodiments, the data portion of the OMA DM command contains a self-explaining TNDS data structure formatted according to XML or WBXML.

A detector 21 detects whether the identification portion 27 contains a predetermined reserved identifier (e.g., a reserved URI). If the reserved identifier is detected, then the detector 21 signals a selector 23 to select an identifier (e.g., a URI) provided at 25 by identification logic 22. The identification logic 22 uses the informational content portion 28 of the received command to determine the identifier 25.

As an example, the identification logic 22 can use the management object identifier from a self-explaining TNDS data structure formatted according to XML or WBXML to resolve the appropriate URI for the corresponding management object in the TNDS data structure. The identification logic 22 would then provide the resolved URI as the desired identifier at 25.

If the detector 21 does not detect the reserved identifier in the identification portion of the command, then the detector 21 signals the selector 23 to select the identifier contained in the identification portion 27.

The output 29 of the logic 20 associates the informational content portion 28 with the identifier 26 selected at 23 in response to operation of the detector 21. This output is provided to the management tree control function of the managed apparatus, which can maintain the management tree according to conventional techniques.

FIG. 3 illustrates exemplary operations that can be performed when processing a received communication element, such as a device management command, used for remote information management according to the invention. In some embodiments, the illustrated operations are performed by the managed apparatus of FIGS. 1 and 2. It is determined at 31 whether the identifier (designated as “ID” in FIG. 3) contained in the identifier portion of the received management command is a predetermined reserved identifier. If not, then operations proceed according to conventional processing of the command, as shown generally at 33. If the reserved identifier is detected at 31, then the informational content portion of the command is used at 32 to produce another identifier (i.e., the needed identifier) to be associated with the informational content portion of the command. Thereafter, conventional processing proceeds as shown at 33.

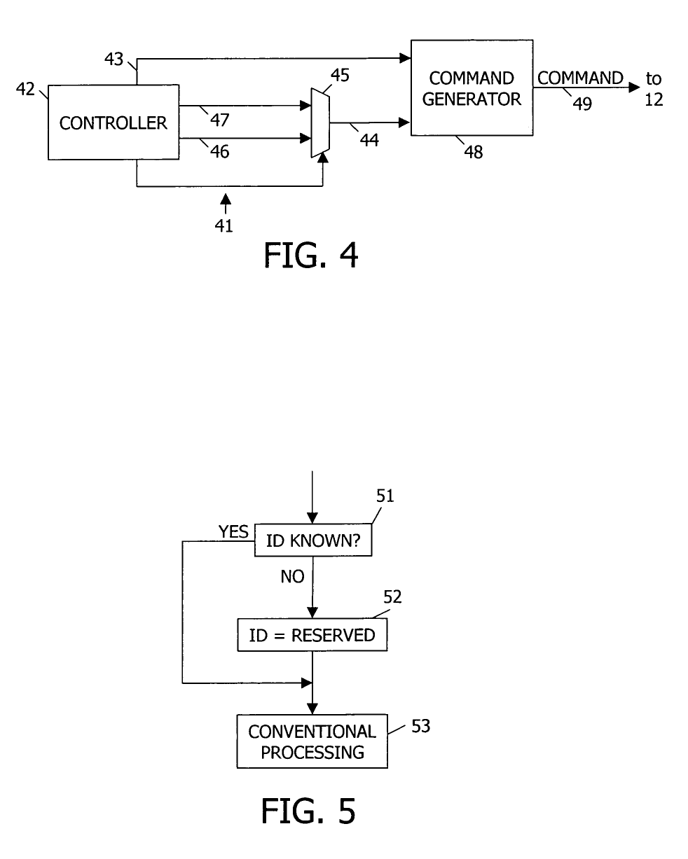

FIG. 4 diagrammatically illustrates the managing apparatus 13 of FIG. 1 in more detail according to exemplary embodiments of the invention. In the apparatus of FIG. 4, a control arrangement 41 provides the content for a communication element, such as a device management command (e.g., an OMA DM command). More specifically, a controller 42 provides an informational content portion 43 (e.g., a self-explaining TNDS data structure formatted according to XML or WBXML) for the command. The control arrangement 41 also provides an identification portion 44 that carries an identifier (e.g., a URI) associated with the informational content contained in the informational content portion 43. Command generator logic 48 can use conventional techniques to produce for transmission to the managed apparatus (see 12 in FIG. 1) a device management command 49 that includes the informational content portion 43 and the identification portion 44.

Normally, when the managing apparatus 11 knows the proper identifier (e.g., a URI) to be associated with the informational content portion 43, the controller 42 will control a selector 45 to select the known identifier 46 to be carried in the identification portion 44 of the command. The provision of a known identifier in the identification portion of the command is conventional practice.

However, if the managing apparatus 11 does not know the identifier that should be associated with the informational content contained in the informational content portion 43, then the controller 42 controls the selector 45 to select a predetermined reserved identifier 47 to be carried in the identification portion 44 of the command. The presence of this reserved identifier 47 (e.g., a reserved URI) in the identification portion 44 of the command will serve to signal the managed apparatus that the informational content portion 43 should be used by the managed apparatus to determine a proper identifier for the informational content of the command.

FIG. 5 illustrates exemplary operations that can be performed to produce a communication element, such as a device management command, used for remote information management according to the invention. In some embodiments, the illustrated operations are performed by the managing apparatus of FIGS. 1 and 4. It is determined at 51 whether the identifier (designated as “ID” in FIG. 5) that should be associated with the informational content of the command is known. If so, then operations proceed according to conventional production of the command, as shown generally at 53. If it is determined at 51 that the identifier is not known, then, at 52, the reserved identifier is chosen to be carried in the identification portion of the command. Thereafter, conventional processing proceeds as shown at 53.

In some OMA DM embodiments, the managed apparatus can indicate in its device description framework (DDF) that it supports the above-described use of a reserved URI when the proper URI is unknown to the managing apparatus. In some embodiments, the DDF also specifies that the reserved URI is supported only with respect to the OMA DM Add Command. Thus, the managing apparatus would be able to use the reserved URI to add management objects in the managed apparatus. However, for example, the managing apparatus would not be able to use the reserved URI in an OMA DM Get Command to retrieve the management object from the managed apparatus. In some OMA DM embodiments, the managed apparatus may use its ACL (Access Control List) to set access rights for the reserved URI such that a managing apparatus can use the reserved URI only if that apparatus is a member of a group to which access is permitted.

Although exemplary embodiments of the invention have been described above in detail, this does not limit the scope of the invention, which can be practiced in a variety of embodiments.

What is claimed is:

1. A method of processing a communication element which is used for remote management of information in a data processing apparatus and which includes an informational content portion and an identification portion associated with the informational content portion, comprising:
in response to the identification portion, using the informational content portion to produce an identifier; and
associating the identifier with information contained in the informational content portion.

2. The method of claim 1, wherein the communication element includes an OMA DM command.

3. The method of claim 2, wherein the OMA DM command is an Add command.

4. The method of claim 2, wherein the informational content portion includes a TNDS object that contains a management object and a management object identifier.

5. The method of claim 1, wherein the informational content portion contains a TNDS object that includes a management object and a management object identifier.

6. The method of claim 5, wherein said using step includes using the management object identifier to produce said first-mentioned identifier.

7. The method of claim 1, wherein the identification portion contains a URI.

8. The method of claim 7, wherein the identifier includes a further URI.

9. The method of claim 1, wherein the identifier includes a URI.

10. The method of claim 1, including detecting that the identification portion contains a predetermined identifier, and performing said using step in response to said detection of said predetermined identifier.

11. The method of claim 1, including receiving the communication element as part of an OMA DM bootstrap process.

12. The method of claim 1, wherein the informational content portion includes data formatted according to one of XML and WBXML.

13. A method of producing a communication element used for remote management of data in a data processing apparatus, comprising:
providing in the communication element an informational content portion: and
providing in the communication element an identification portion which is associated with the informational content portion and which signals to the data processing apparatus that the data processing apparatus is to use the informational content portion to produce an identifier for association with information contained in the informational content portion.

14. The method of claim 13, wherein said last-mentioned providing step includes providing within the identification portion a predetermined identifier whose presence in the identification portion effectuates the signaling to the data processing apparatus.

15. A data processing apparatus, comprising:
an input for receiving from a source external to said data processing apparatus a communication element which is used for remote management of information in said data processing apparatus and which includes an informational content portion and an identification portion associated with the informational content portion; and
logic coupled to said input and responsive to the identification portion for using the informational content portion to produce an identifier, said logic also associating the identifier with information contained in the informational content portion.

16. The apparatus of claim 15, provided as a portable data processing apparatus.

17. The apparatus of claim 15, wherein said logic detects that the identification portion contains a predetermined identifier, and produces said first-mentioned identifier in response to detection of said predetermined identifier.

18. An apparatus for producing a communication element used for remote management of data in an external data processing apparatus, comprising:
an input that provides for the communication element an informational content portion and an identification portion which is associated with the informational content portion and which signals to the external data processing apparatus that the external data processing apparatus is to use the informational content portion to produce an identifier for association with information contained in the informational content portion; and
logic coupled to said input to provide the communication element containing therein the informational content portion and the identification portion.

19. The apparatus of claim 18, provided in one of a server computer and a smart card.

20. The apparatus of claim 18, wherein the identification portion contains a predetermined identifier whose presence in the identification portion effectuates the signaling to the external data processing apparatus.
